(19) United States
(12) Patent Application Publication
(10) Pub. No.: US 2006/0142678 A1
(43) Pub. Date: Jun. 29, 2006

(54) Device for relieving menstrual cramps

(76) Inventors: Jules Steven Hecht, New York, NY (US); Roberta Gilston Hecht, New York, NY (US)

Correspondence Address: LITMAN LAW OFFICES, LTD, PO BOX 15035, CRYSTAL CITY STATION, ARLINGTON, VA, 22215, US

(21) Appl. No.: 11/022,807

(22) Filed: Dec. 28, 2004

(51) Int. Cl. A61H 7/00

(52) U.S. Cl. 601/135; 601/134; 601/137; 606/204

(57) ABSTRACT

The device for relieving menstrual cramps is a handheld acupressure tool having a support, a handle and three tips extending from the support. The tips are strategically placed at specific distances from each other. The tips are designed to contact the palm of a hand between the index finger and the middle finger, between the ring finger and the little finger and on the fleshy part of the palm near the thumb. The handle is placed on the surface opposite the tips to aid the user in pressing the device into the hand. The device may also have depressions disposed on the same side as the handle. The depressions should align with the tips so that pressure placed on the device through the depressions will be directly transferred to the tips and subsequently onto the palm that the device is being used upon.

### BACKGROUND OF THE INVENTION

1. Field of the Invention

The present invention relates to pressure application devices, and particularly to an acupressure tool designed to apply pressure on multiple areas of a palm or other part of the body.

2. Description of the Related Art

Today many people lean toward alternative medicines to find relief from health ailments, health conditions or addictions. Acupressure is one type of alternative medicine. Acupressure uses the fingers, thumbs, knuckles and elbows to apply gentle pressure on key body points, thereby helping to stimulate energy flow throughout the body. Acupressure has been used in many applications, such as in relieving stiff necks, headaches, arthritis, stress, pains, menstrual cramps, etc. Acupressure can be self-administered once the proper points are determined.

For women, pain from menstrual cramps can be relieved or removed by applying pressure to three key points on the palm of the hand. The three points are between the index finger and the middle finger, between the ring finger and the little finger and on the fleshy part of the palm near the thumb. By simultaneously applying pressure on these points, relief can be had from menstrual cramps. Pressure may be applied to these points by hand for those familiar with acupressure. However, for those unfamiliar with acupressure, the points may be difficult to determine or may be improperly determined. Other problems with manually applying pressure to the points are that the fingers may become fatigued, and unequal pressure may be applied to the different points. It is preferable that equal pressure be applied to these points at the same time in order to achieve maximum therapeutic effect. A device is desired that can easily determine the three key points for relieving menstrual pain and apply equal pressure on these points at the same time. Thus, a device for relieving menstrual cramps solving the aforementioned problems is desired.

### SUMMARY OF THE INVENTION

The device for relieving menstrual cramps is a handheld acupressure tool having a support, a handle extending from a top surface of the support, and three tips extending from the bottom surface of the support. The tips are placed at specific distances from each other to contact a palm of the hand. Two tips are relatively near each other to contact the palm between the index finger and the middle finger and between the ring finger and the little finger. The third tip is placed relatively far from the other two tips and is designed to contact the fleshy part of the palm near the thumb. The location of the tips defines the vertices of a triangle. The points are not random points. Separately, the points on the palm correspond to the kidney/adrenal glands, the eyes, and the throat. Simultaneously applying pressure on these points has been known since ancient times to relieve menstrual cramping and pain.

The tips are generally bulbous, having a nipple or knob-like shape. The width of the smallest point farthest from the support is about 5/16 of an inch. The size is appropriate for applying adequate (but not excessive) pressure on all three points simultaneously. Rounded tips may not provide adequate pressure. Likewise, a pointed tip would be painful and may puncture the palm.

The handle is placed on the top surface to aid the user in pressing the device on the hand that the device is being used upon. The handle is fixed to the support, but may be selectively removable from the support. Depressions may also be disposed on the top surface of the support. There are three depressions corresponding to the number of tips. The depressions are aligned with each tip. As a result, pressure placed on the device through the depressions will be directly transferred to the tips and subsequently onto the palm that the device is being used upon. Both the depressions and the handle help the user to press the device on the hand it is being used upon. The device need not have both the handle and the depressions, but may have either the handle only or the depressions only.

In use, the user places the left hand on a flat surface, such as a desktop or a knee, palm upward, and then places the device on the palm of the left hand. The tips are aligned at the specific points mentioned above. The user then places the thumb, the index finger and the middle finger of the right hand in the depressions to place pressure on the device and presses the tips into the specific points on the palm. Women having long fingernails can use the device without ruining the nails or having the nails become an impediment when using the device. In this situation, the user utilizes the handle to press the tips into the palm, rather than placing their fingers and thumb in the depressions.

These and other features of the present invention will become readily apparent upon consideration of the following specification and drawings.

### BRIEF DESCRIPTION OF THE DRAWINGS

FIG. 1 is an environmental, perspective view of a device for relieving menstrual cramps according to the present invention.

FIG. 2 is a bottom perspective view of the device for relieving menstrual cramps.

FIG. 3 is a top perspective view of the device for relieving menstrual cramps.

FIG. 4 is a top view of the device for relieving menstrual cramps disposed on a left hand.

Similar reference characters denote corresponding features consistently throughout the attached drawings.

### DETAILED DESCRIPTION OF THE PREFERRED EMBODIMENTS

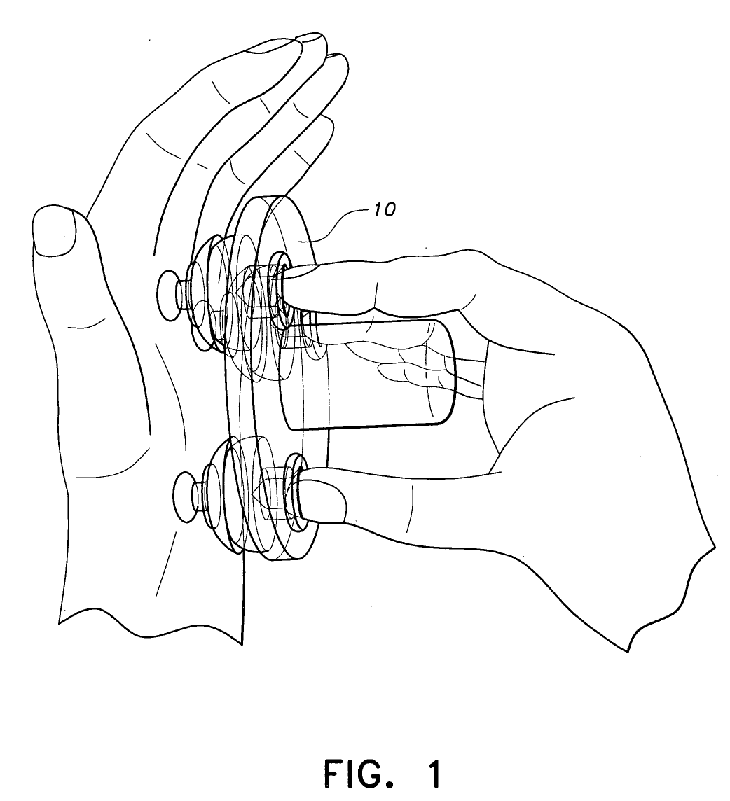

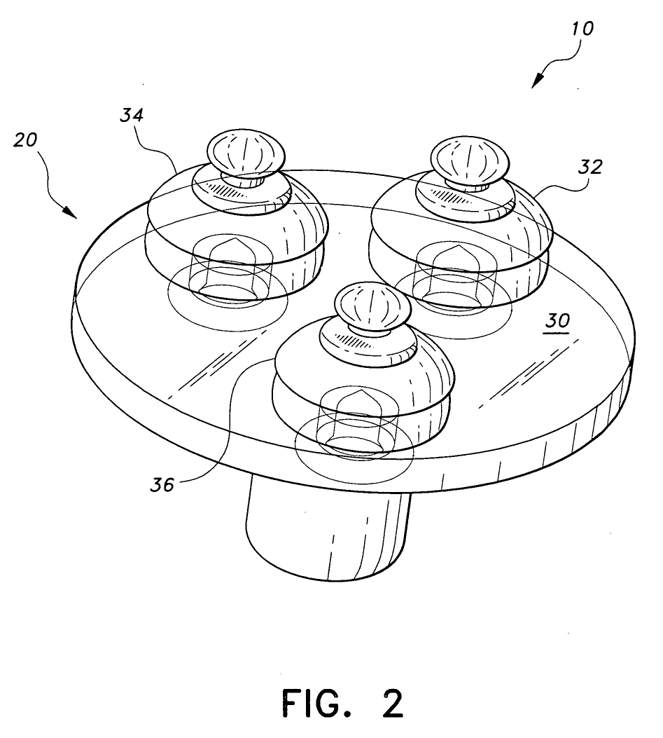

The present invention is a device for relieving menstrual cramps, the device being generally designated as 10 in the drawings. As shown in FIGS. 1, 2 and 3, the device 10 is a handheld acupressure tool having a support 20, a handle 28 and tips 32, 34 and 36. The support 20 has a top surface 22 and a bottom surface 30. The top surface 22 has three depressions 24 and receives the handle 28. The bottom surface 30 has three tips 32, 34 and 36 protruding or extending therefrom.

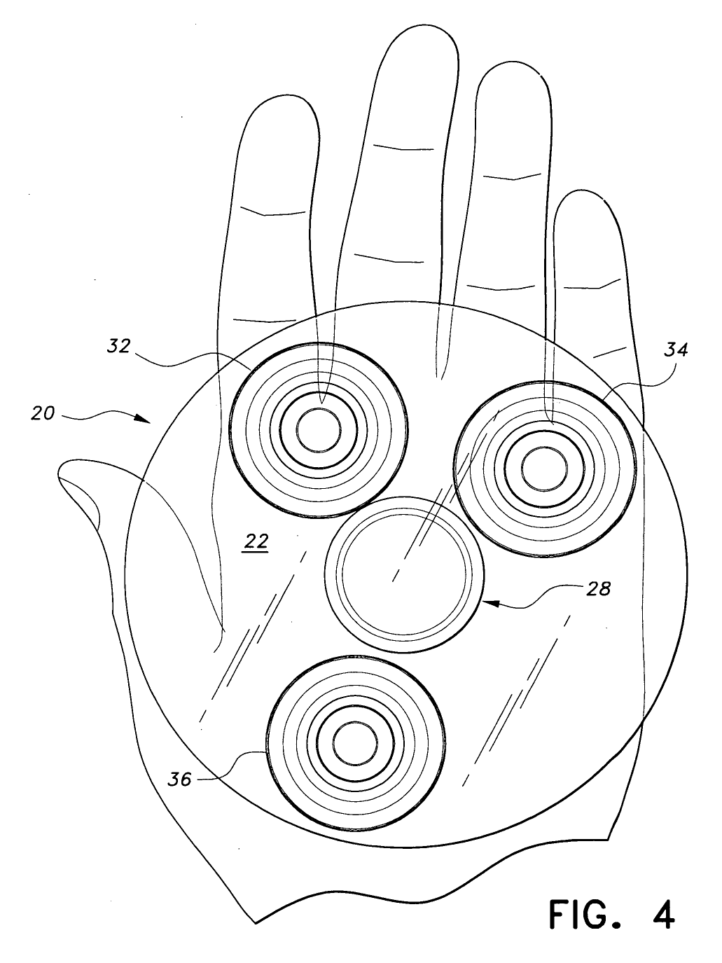

Referring to FIG. 4, the tips 32, 34 and 36 are placed at specific distances from each other. Tips 32 and 34 are relatively close to each other, while tip 36 is farther from tips 32 and 34. The distance between tip 32 and tip 34 is about one and three-eighths of an inch, the distance between tip 32 and tip 36 is about one and seven-eighths of an inch, and the distance between tip 34 and tip 36 is about one and three-fourths inches. Generally the tips 32, 34 and 36 form a scalene triangle. The angle between the sides of the triangle with a vertex at tip 32 is about 650; with a vertex at tip 34, about 74°; and with the vertex at tip 36, about 410. It will be understood that the above dimensions are representative dimensions only, and that distances and angles may vary within predetermined tolerances. Tip 32 is positioned to contact the palm of the left hand between the index finger and the middle finger while tip 34 simultaneously contacts the left hand between the ring finger and the little finger. The third tip 36 contacts the fleshy part of the palm of the left had near to the thumb.

The device 10 works on either hand, but works best on the left hand. If the device 10 is used on the palm of the right hand, the tip 36 contacts the fleshy part of the palm near the thumb, while tips 32 and 36 contact the opposite positions on the palm. Tip 32 contacts the space between the ring finger and the little finger, and tip 34 contacts the space between the index finger and the middle finger. The location of the tips 32, 34 and 36 form a triangle. Applying simultaneous and equal pressure on these points has relieved and/or removed menstrual cramping and pain for many women.

The tips 32, 34 and 36 are generally bulbous, being nipple-shaped or knob-like. The smallest point on each tip 32, 34 and 36 is disposed opposite the support 20. The width of the smallest point is about 5/16, to ¼ of an inch. The size is satisfactory for applying adequate pressure on the palm. A nipple- or knob-shaped tip is preferred. Alternatively, the tips may be rounded, but may not provide adequate pressure. Likewise, the tips may be pointed, but cautions may be required to ensure that the pointed tips are not painful and do not puncture the palm. In some embodiments, the tips may further have a degree of resilience, so that the tips are not so rigid that the pressure applied causes pain.

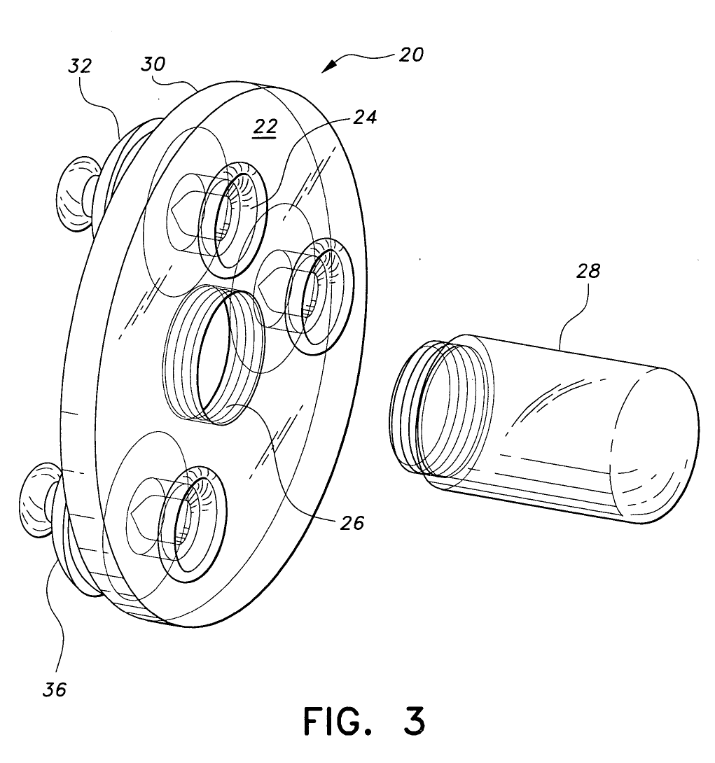

Referring now to FIG. 3, the top surface 22 of the support 20 is shown having depressions 24 and having a handle 28. Both the depressions 24 and the handle 28 help the user to press the device 10 on the hand that the device 10 is being used upon. The handle 28 may be fixed to the support 20, or may be selectively removable from the support 20. Three depressions 24 are disposed on the top surface 22 of the support corresponding to the number of tips 32, 34 and 36. The depressions 24 are aligned over each tip 32, 34 and 36. As a result, pressure placed on the device 10 through the depressions 24 will be directly transferred to the tips 32, 34 and 36 and subsequently transferred onto the palm that the device 10 is being used upon. The device 10 may be equipped with both the handle 28 and the depressions 24, or with either the handle 28 or the depressions 24.

In use, the user places her left hand on a flat surface, such as a desktop or a knee, and then places the device 10 on the palm of the left hand. As best shown in FIG. 4, the tips 32, 34 and 36 are then aligned at the specific points mentioned above. The user then applies pressure to the left palm via the tips 32, 34 and 36 of the device 10 by placing fingers in each of the depressions 24. The thumb, index finger and middle finger of the right hand are placed in the depressions to put pressure on the specific points of the palm via the tips 32, 34 and 36. As an alternative, the device 10 may be used to apply pressure on the hand by using the handle 28. The handle 28 is advantageous for allowing women having long fingernails to use the device 10 without sacrificing their nails or having the nails become an obstacle when using the device 10.

The device 10 may be manufactured as one piece by injection molding or may be made in pieces and joined together. Generally, a sturdy plastic is used to make the entire device 10 with the tips 32, 34 and 36 being equally as hard as the rest of the device 10. Alternatively, the tips 32, 34 and 36 may be resilient, coated with a resilient material or semi-resilient.

It is to be understood that the present invention is not limited to the embodiments described above, but encompasses any and all embodiments within the scope of the following claims.

We claim:

1. A device for relieving menstrual cramps, comprising:
a support having a top surface and a bottom surface; and
a plurality of tips extending from the bottom surface of the support, the tips being spaced apart in a pattern adapted for applying pressure to acupressure trigger points on a palm of a hand of a woman experiencing menstrual cramps for relieving pain associated with the clamps.

2. The device according to claim 1, further comprising a handle extending from the top surface of the support.

3. The device according to claim 1, wherein said plurality of tips comprises three tips.

4. The device according to claim 1, wherein the tips are nipple-shaped.

5. The device according to claim 1, wherein the tips are knob-shaped.

6. The device according to claim 1, wherein the tips are bulbous.

7. The device according to claim 1, wherein said support is rigid and said tips are rigid.

8. A device for relieving menstrual cramps, comprising a rigid support having a top surface, a bottom surface, a plurality of indentations formed in the top surface of the support, and a plurality of tips extending from the bottom surface of the support.

9. The device according to claim 8, wherein the plurality of tips extending from the bottom surface of the support are aligned with the depressions disposed on the top surface of the support.

10. The device according to claim 8, wherein said plurality of tips comprises three tips.

11. The device according to claim 8, wherein the tips are knob-shaped.

12. The device according to claim 8, wherein the tips are nipple-shaped.

13. The device according to claim 8, wherein the tips are bulbous.

14. The device according to claim 8, further comprising a handle extending from the top surface of the support.

15. A device for relieving menstrual cramps, comprising:
a support having a top surface and a bottom surface;
a handle extending from the top surface of the support; and
a plurality of tips extending from the bottom surface of the support.

16. The device of claim 15, wherein the handle is centrally located on the top surface of the support.

17. The device of claim 15, wherein the handle is removably attached to the support.

18. The device of claim 15, wherein said plurality of tips comprises three tips.

19. The device of claim 17, wherein the tips are nipple-shaped.
